(19) United States
(12) Patent Application Publication
(10) Pub. No.: US 2003/0047277 A1
(43) Pub. Date: Mar. 13, 2003

(54) Labelling process

(76) Inventors: Norman Bell, Carnforth (GB); Etienne Lernoux, Ville-Houdlemont (FR)

Correspondence Address: ExxonMobil Chemical Company, Law Technology, PO Box 2149, Baytown, TX, 77522-2149, US

(21) Appl. No.: 10/130,372

(22) PCT Filed: Dec. 20, 2000
(86) PCT No.: PCT/US00/34836

(30) Foreign Application Priority Data
Dec. 23, 1999 (EP) 99310560.0

(51) Int. Cl. B32B 31/00

(52) U.S. Cl. 156/290; 156/307.3; 156/308.6

(57) ABSTRACT

The invention provides a labelling process comprising providing a container and a polymeric film label, applying water-based adhesive to one side of the label and applying the side of the label to which adhesive has been applied to the container, characterised in that the adhesive is applied to the label in a discontinuous pattern. The pattern is preferably formed from non-contiguous indicia, in particular dots.

The invention relates to a process of labelling, and to products of this process such as labelled containers. The process relates in particular to a process of applying polymeric film labels to containers using a water-based adhesive.

It is common to apply labels to containers formed from polymeric material or glass. For instance, plastic containers for liquid detergent regularly require labelling so as to provide the necessary customer information on the container.

One widely used and well known labelling technique uses a water based adhesive and is commonly known as water-based cold glue labelling or “patch labelling”. Around 17% of all labelling in Europe is carried out using this process. In such a labelling process water-based adhesive is applied to a label, which is usually held in a stack in a magazine, the label is then transferred to a transfer means and subsequently applied to the relevant container.

The use of water-based adhesive means that drying must take place by evaporation of the water. Consequently, labels are almost exclusively paper-based, paper having a high water vapour transmission rate (WVTR) so that drying of the adhesive is not hindered. Drying takes place in a few hours after application of the label to the container. The use of paper in conjunction with water-based adhesives, while satisfying the basic requirements for labelling, leads to associated problems which are well known within industry, e.g. poor tear resistance, moisture sensitivity, relatively poor durability, etc.

Furthermore, it is becoming more common to recycle polymeric and glass containers and if the label is formed from paper, it is not possible to recycle the entire container without removing the label first. When the container is polymeric any contamination with residual paper fibres leads to problems with the recycling process.

Polymeric film materials are known for use as labels in various fields, but they have to date had very limited use in low demand/non-critical labelling applications of the types discussed above in which the adhesive is water-based. The main reason for this limited use is the drying process of the water-based adhesive, i.e. evaporation of water. With polymeric non-permeable materials, it is very difficult for the moisture vapour to escape, this being necessary to accelerate the drying process. The associated problem is entrapped moisture leading to a long time being necessary to obtain a satisfactory bond of the label. This results in label movement during handling and storage, and a visible bubbling effect at the surface of the label, which is aesthetically undesirable. Bubbling occurs in particular at elevated temperature (eg Summer conditions in certain countries).

Polymeric film materials such as oriented polypropylene (OPP) based labels, which are commonly used in other fields, such as hot melt applied wrap-around labels and self-adhesive labels, have in the past been found to be inappropriate as replacements for paper labels in the cold glue processes discussed above. As previously stated, drying of the water-based adhesive is inhibited to an excessive extent. We believe this is due to the low WVTR of such materials.

Accordingly, it is an object of the invention to devise a labelling system in which polymeric film labels may be applied to containers using a water-based adhesive, without inhibiting drying to an excessive extent. In particular it would be desirable to provide a system in which OPP based labels may be used.

We have surprisingly found that this problem can be solved by modifying the pattern in which the adhesive is applied to the labels. Generally, the water-based adhesive is applied in a simple pattern of continuous stripes across the length or width of the label. We have found that by modifying this standard pattern, acceptable drying wit polymeric (eg OPP) labels is nevertheless obtained with a water-based adhesive

According to a first aspect of the invention we provide a labelling process comprising providing a container and a polymeric film label, applying water-based adhesive to one side of the label and applying the side of the label to which adhesive has been applied to the container, characterised in that the adhesive is applied to the label in a discontinuous pattern.

Surprisingly, we find that modifying the pattern in which the adhesive is applied makes a substantial difference to the drying process and finally allows the use of polymeric labels such as OPP based film labels. We find a major reduction in the bubbling effect and a significant acceleration of the drying of the adhesive. An advantage of the process is that polymeric labels are used. These are beneficial in various ways. In particular, polymeric film labels can have greater tear resistance than paper labels. Due to their lower WVTR they can also have greater moisture resistance when the container is in the consumer environment. It also facilitates recycling of the entire product when the polymeric label is formed from material of the same broad type as polymeric material used to form the container.

In the process the label is applied to a container. This container may be made of glass or metal, but is preferably formed from a polymeric material, such as polyester, polyethylene or polypropylene. The container may be intended for any purpose, eg for food or drink (e.g. milk, alcoholic drinks such as beer) and household products. Containers for household products, in particular household cleaning products, which are often exposed to moisture in use, benefit particularly from the invention.

A particular advantage of the invention is that the label is formed from a polymeric material and convenient drying times are achieved. The film may be multi-layer or monolayer. The surface of the film may be modified, for instance by means of the coextrusion process or by means of additional coatings or any other additional processes.

Preferably the film comprises a propylene polymer such as propylene homopolymer or copolymers of propylene with minor amounts of other unsaturated monomer such as ethylene and/or butylene. Another preferred structure comprises an ethylene polymer such as ethylene homopolymer or copolymers of ethylene with minor amounts of other unsaturated monomer such as butylene, hexene or octene. In a multi-layer film the base or substrate layer is preferably formed from a propylene or ethylene polymer. Preferably, the label comprises a polypropylene polymer film with additional coatings which are especially formulated to give characteristics which maximise labelling processability and cold adhesive receptivity.

The invention is especially beneficial in labels formed from films having a WVTR of not more than 50 g/m²/day (ASTM F1249, 38 C, 90% RH).

The label may be of any conventional dimensions. The thickness is generally from 30 to 100 μm. The length and width are generally from 40 to 300 mm and from 20 to 300 mm, respectively.

The adhesive used in the process of the invention is a water-based adhesive. It is preferably a polymer emulsion or micro-emulsion. It can be a synthetic emulsion, eg an emulsion based on acrylic polymers, or vinyl acetate polymers (usually copolymers such as vinyl acetate/ethylene or vinyl acetate/maleic acid). It may also be an emulsion based on modified natural latex (eg styrene butadiene rubber, neoprene butadiene rubber, acrylate butadiene rubber). All of these dispersions can optionally be modified by the addition of various synthetic and natural resins and additives (eg polymers in solution, rosin compounds, rheological agents etc), which bring specific properties in terms of flow, anchorage, tackiness, speed of drying, etc. Such emulsions usually have at least 40% solids content. The adhesive is preferably such an emulsion but may be based on casein or dextrin. These materials tend to have lower solids content (20 to 30%). They are less preferred for polymeric containers, but can be suitable when the container is formed from glass or metal.

In the invention the drying process is assisted by preferred emulsion adhesives which have solids content of at least 50%, especially around 60%. Solids content is generally not more than 65 or 70%.

The process is preferably a process in which labels are provided as a stack in a label magazine. A rotating pallet picks up adhesive from a rotating adhesive cylinder and applies it to the top label in the stack. The label is then transferred to a label transfer drum, on which it is held by means such as vacuum suction and/or grippers. From the transfer drum it is applied on its adhesive side to the container. Further details of such a process are discussed below in relation to the drawings.

In the process the adhesive is normally applied at ambient temperature, namely from 20 to 30 C.

In the invention it is essential that the adhesive is applied in a discontinuous pattern. That is, it is not applied (as is conventional) as continuous stripes extending across the length or width of the label. In particular, the pattern comprises a series of non-contiguous indicia. Suitable indicia include dots (of any shape, eg rectangular or elliptical but preferably substantially circular), crosses, stars or short, discontinuous lines. Preferably the pattern comprises at least 3, more preferably at least 5, in particular at least 9, of such indicia per cm².

Preferably the indicia are distributed substantially uniformly, that is the minimum distance between two indicia is substantially the same across substantially the entire surface area of the label.

The minimum distance between the indicia is preferably at least 0.5 mm, more preferably at least 1 or 1.5 mm, but is generally not more than 5 mm.

If dots are used their maximum diameter is preferably not more than 4 mm, more preferably not more than 2 or 1.5 mm. It is generally at least 0.5 mm.

In the invention it is preferred that not more than 50%, more preferably not more than 40%, most preferably not more than 30%, of the surface area of the label has adhesive applied. Generally however at least 20%, more preferably at least 25%, of the surface area has adhesive applied, in order to obtain adequate adhesion of the label to the container. This is in contrast with the traditional pattern of stripes in which at least 80%, usually close to 100%, of the surface area has adhesive applied. In addition to the non-contiguous indicia, it is possible to include some stripes in the pattern although it is preferred that they are absent. If they are present, they are not continuous across the width or length of the label and not more than 60%, preferably not more than 50%, of the area taken up by adhesive is formed by such stripes.

The indicia are generally of an overall shape which is rounded and not elongate. The ratio between their maximum and minimum dimensions is preferably not more than 3:1, in particular not more than 2:1 and is often less than 1.5:1.

Conventional labelling systems of the types discussed above use a pallet to transfer adhesive from the adhesive cylinder to the label. In conventional systems the surface of this pallet usually consists of very fine, shallow grooves, which are continuous across the width. These are designed by the machine builder to aid adhesive pick-up. This results in adhesive coverage of at least 75 or 80%, often about 100%.

The pallets are generally made of steel or alloy materials. In the invention it is possible to provide pallets having a surface configuration chosen in accordance with the pattern of adhesive which is applied to the label. These pallets may be made of conventional materials such as those mentioned above.

However, we have found that in the invention it is particularly convenient to provide surface configurations by means of pallets having a surface layer formed from a flexible material. The materials used for formation of flexographic printing plates, such as rubber or photopolymer, are particularly suitable for this purpose. Thus in the invention a rotary steel pallet is provided, with or without conventional grooves (preferably without) and is of lower thickness than is conventional and to the surface of this pallet is attached a plate formed from rubber, photopolymer or other flexible material configured to apply an appropriate pattern to the label. For instance, if the pattern is a series of circular dots uniformly distributed across the surface of the label, the plate used will have a series of uniformly distributed circular dots in relief.

The invention will now be illustrated with reference to the accompanying drawings.

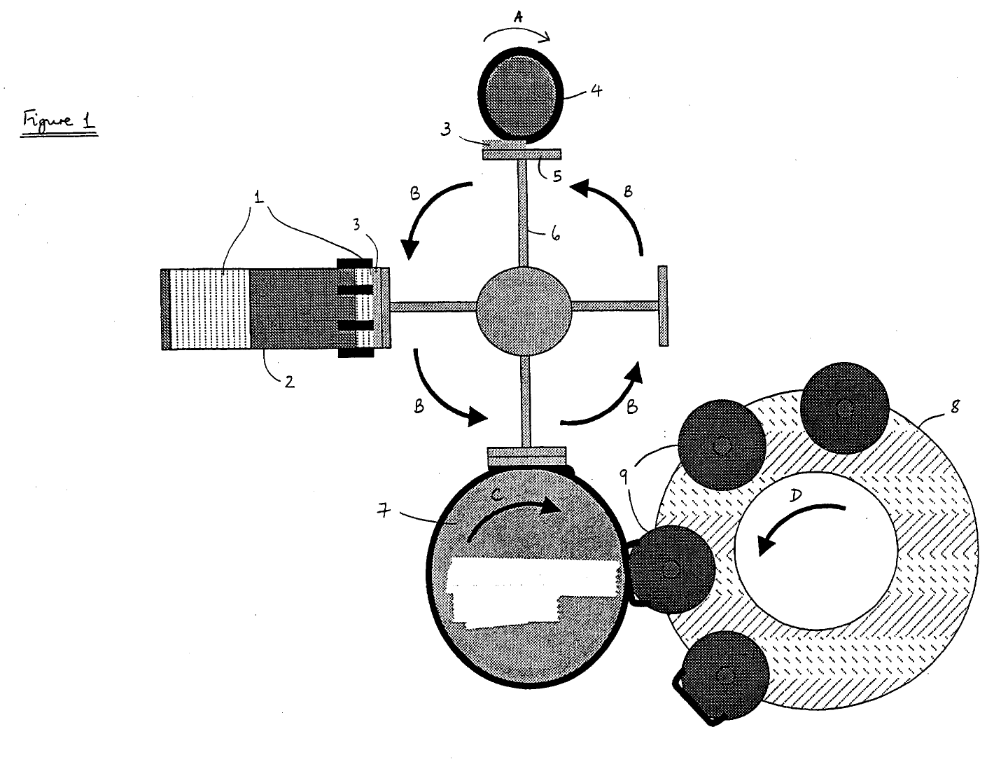

FIG. 1 shows a schematic description of a patch labelling process.

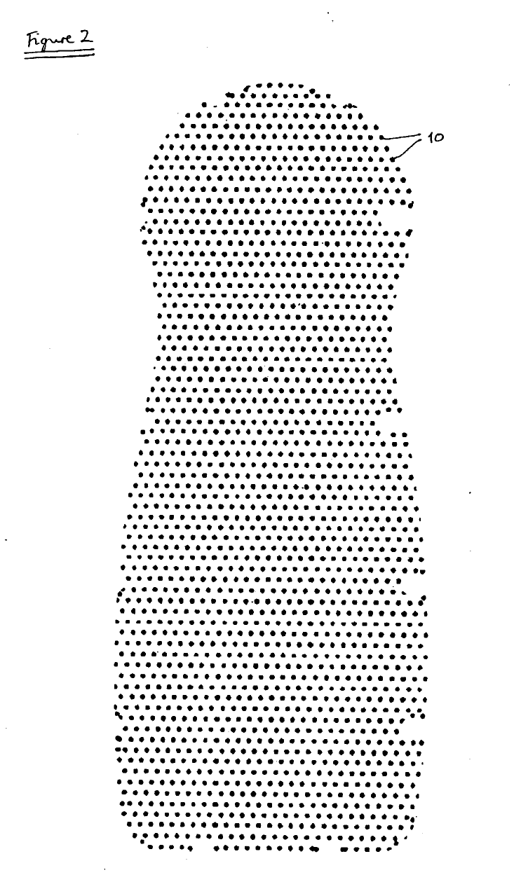

FIGS. 2, 3, 4 and 5 show examples of the discontinuous pattern of adhesive which can be used in the invention.

In FIG. 1 a labelling process in which the invention may be applied is illustrated. Labels 1 are held in a label magazine 2. Adhesive 3 is applied from an adhesive drum 4 (which rotates in the direction of the arrow A) onto the pallet 5, which is rotating on arm 6 in the direction of the arrows B. As the pallet 5 passes the drum 4 it picks up adhesive 3 and travels to the label magazine 2, where it picks up the top label 1 in the stack. The label 1 is caused to adhere to the pallet 5 by means of the adhesive and is transferred to the transfer drum 7. The non-adhesive side of the label 1 is held on the drum 7 by means of vacuum suction and/or grippers and, as the transfer drum 7 rotates in the direction of the arrow C, is transferred to the container holder 8 rotating in the direction of arrow D, where the adhesive side of the label is caused to adhere to container 9.

FIGS. 2 to 5 show examples of the various adhesive patterns which can be used. The pattern of FIG. 2 is most preferred. The discontinuous pattern is formed by a series of non-contiguous indicia which are substantially circular dots 10. The dots 10 are arranged in rows and the distance between them is approximately 1.6 mm. The diameter of each dot is approximately 1 mm.

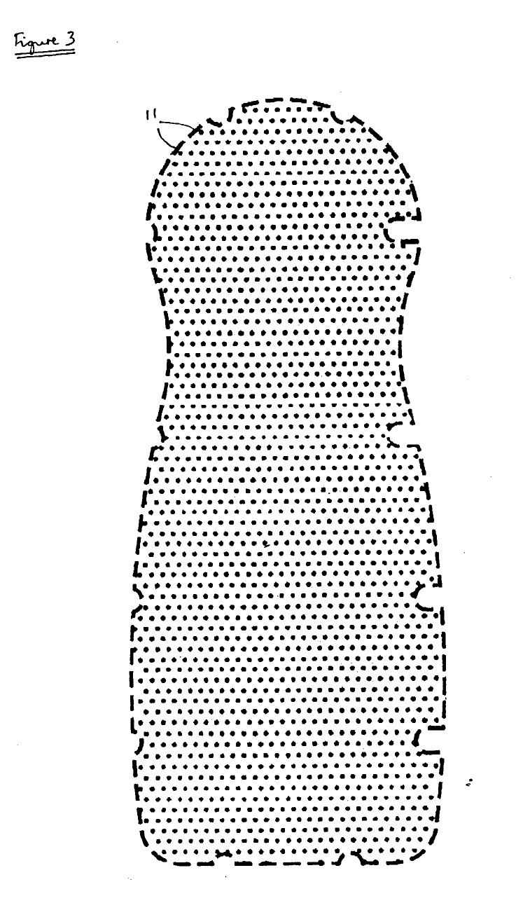

A variant of this pattern is shown in FIG. 3 in which discontinuous lines 11 are provided around the perimeter of the label. The length of each line is approximately 1.8 mm and the distance between the lines is approximately 1.6 mm. The width of each line is approximately 1 mm.

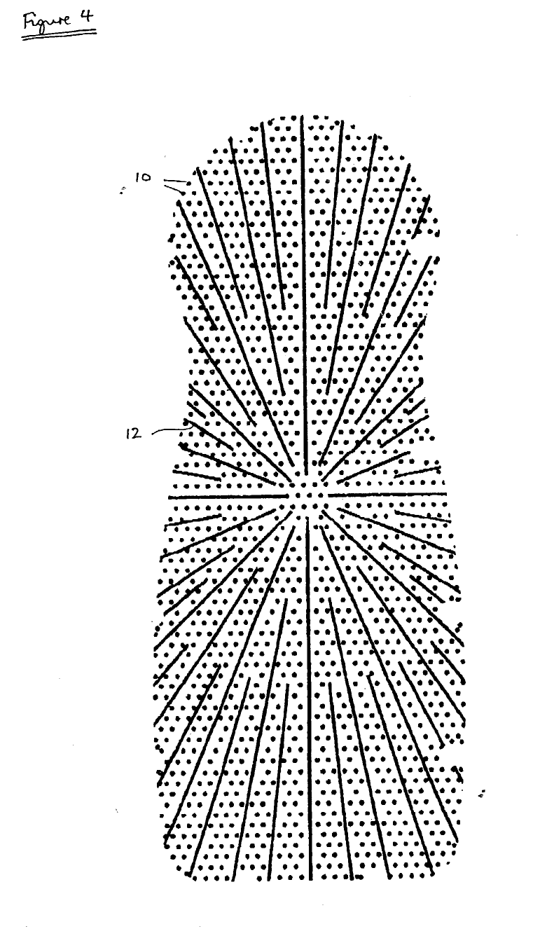

FIG. 4 shows a variant on the pattern of FIG. 2. Superimposed on a pattern of discontinuous non-contiguous dots 10 are stripes 12. These take up approximately 40% of the area to which adhesive is applied.

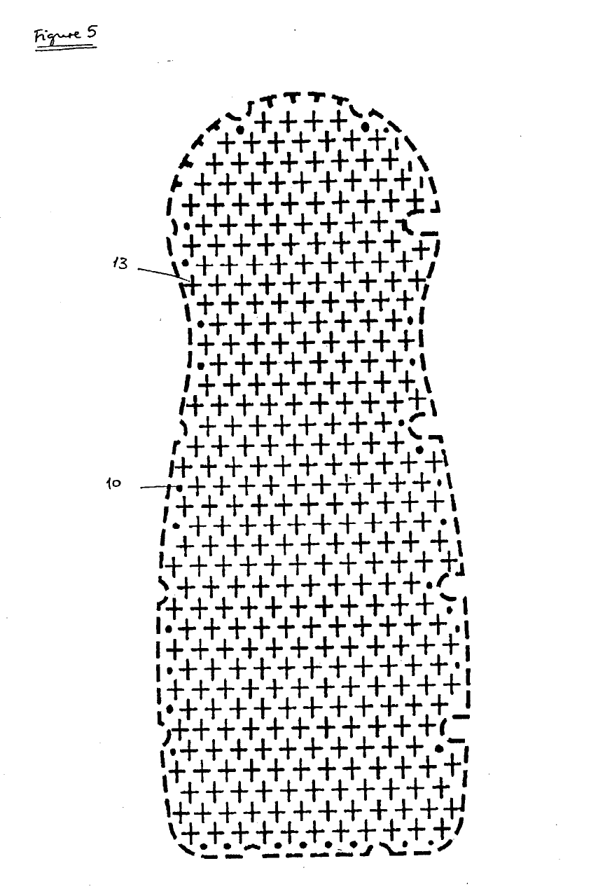

In FIG. 5 the non-contiguous indicia are crosses 13 of height 5 mm and width 4 mm (thus the ratio between their maximum and minimum dimensions is 5:4). A perimeter pattern the same as that shown in FIG. 3 is also provided Some dots 10 may also be provided.

As an example, adhesive was applied in the pattern of FIG. 2 to a label having the shape of FIG. 2. The labelled containers were placed in an oven at 40 C. immediately after labelling. The oven is used in order to accelerate drying and give a rapid idea of whether bubbling is likely to occur. As a comparison, the same adhesive was applied in the standard configuration. With the pattern of FIG. 2, no bubbling was observed but with the standard configuration, a significant level of bubbling was observed within a few hours. In another test, when the pattern of FIG. 2 was used and drying carried out at room temperature, acceptable dryness was obtained after 3 days at room temperature. In contrast, the same adhesive applied in the standard configuration was still almost completely wet after the same period at room temperature.

1. A labelling process comprising providing a container and a polymeric film label, applying water-based adhesive to one side of the label and applying the side of the label to which adhesive has been applied to the container, characterised in that the adhesive is applied to the label in a discontinuous pattern.

2. A process according to claim 1 in which the label has water-vapour transmission rate not more than 50 g/m² day.

3. A process according to claim 1 or claim 2 in which the container is formed from a polymeric material.

4. A process according to any preceding claim in which the container is a container for food, drink or a household product.

5. A process according to any preceding claim in which the adhesive is an emulsion having solids content at least 40%, preferably at least 50%.

6. A process according to any preceding claim in which the adhesive is applied at a temperature of from 20 to 30 C.

7. A process according to any preceding claim in which the adhesive is applied in a pattern of non-contiguous indicia.

8. A process according to claim 7, in which the pattern comprises at least 3, preferably at least 9 indicia per cm².

9. A process according to claim 7 or claim 8, in which the indicia are dots, preferably substantially circular dots.

10. A process according to any preceding claim in which not more than 40% of the surface area of the label has adhesive applied.

11. A process according to any preceding claim in which the adhesive is applied as a pattern of substantially uniformly distributed non-contiguous indicia having a non-elongate shape such that the ratio between their maximum and minimum dimensions is not more than 2:1.

12. A process according to any preceding claim in which the adhesive is applied to the label by means of a pallet having a surface layer which is formed from a material configured to apply the predetermined adhesive pattern to the label and is formed from rubber or photopolymer.

13. A process according to any of claims 1 to 11 in which the adhesive is applied to the label by means of a pallet which is made of steel and a pattern is engraved in the surface of the steel pallet so as to apply the predetermined adhesive pattern to the label.
